(19) United States
(12) Patent Application Publication
(10) Pub. No.: US 2007/0005597 A1
(43) Pub. Date: Jan. 4, 2007

(54) Name classifier algorithm

(76) Inventor: Charles Kinston Williams, Fairfax, VA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/281,885

(22) Filed: Nov. 18, 2005

Related U.S. Application Data
(60) Provisional application No. 60/630,037, filed on Nov. 23, 2004.

(51) Int. Cl. G06F 17/30

(52) U.S. Cl. 707/6

(57) ABSTRACT

A particular algorithm for classifying a name includes accessing a name and dividing the name into a series of n-grams including at least a first n-gram and a second n-gram. At least the first n-gram and the second n-gram are concatenated to form a concatenated n-gram, and a likelihood is determined that the concatenated n-gram belongs to a first language. A likelihood is also determined that the name belongs to the first language based on the likelihood that the concatenated n-gram belongs to the first language.

### CROSS-REFERENCE TO RELATED APPLICATIONS

This application claims priority from U.S. Provisional Application Ser. No. 60/630,037, filed on Nov. 23, 2004, and entitled “NAME CLASSIFIER ALGORITHM,” the entire contents of the prior application being incorporated herein in their entirety for all purposes.

### TECHNICAL FIELD

This disclosure relates to name processing.

### BACKGROUND

Various algorithms exist for classifying names as belonging to a particular language, including algorithms that are based on n-gram analysis. Various algorithms also exist for categorizing documents in large collections to facilitate information retrieval.

### SUMMARY

According to one aspect, various algorithms are described for classifying names. Some of these algorithms use information on the relative frequency of the name in one language versus other languages.

According to a general aspect, a method includes accessing a name and dividing the name into a series of n-grams including at least a first n-gram and a second n-gram. The method concatenates at least the first n-gram and the second n-gram to form a concatenated n-gram, and determines a likelihood that the concatenated n-gram belongs to a first language. The method further determines a likelihood that the name belongs to the first language based on the likelihood that the concatenated n-gram belongs to the first language.

Implementations may include one or more of the following features. For example, the method may include classifying the name as belonging to the first language based on the likelihood that the name belongs to the first language. The first n-gram and the second n-gram need not be sequential, may overlap, and/or may be separated in the name. The method may include normalizing the likelihood that the name belongs to the first language.

The method may include determining likelihoods that each of a series of concatenated n-grams belong to the first language. Determining the likelihood that the name belongs to the first language may be based on the determined likelihoods that each of the series of concatenated n-grams belongs to the first language. Determining the likelihood that the name belongs to the first language may include adding up the likelihoods that each of the series of concatenated n-grams belongs to the first language. Determining the likelihood that the name belongs to the first language may include dividing the sum of the likelihoods by the number of concatenated n-grams added up.

The method may include determining a likelihood that the concatenated n-gram belongs to a second language. The method may include determining a likelihood that the name belongs to the second language based on the likelihood that the concatenated n-gram belongs to the second language. The method may include classifying the name as belonging to either the first language or second language based on the likelihoods that the name belongs to the first language and the second language.

Determining the likelihood that the concatenated n-gram belongs to the first language may include basing the determination on the following term: 0.5+(0.5*(number of times the n-gram occurs in the first language))/(number of times the most common n-gram occurs in the first language).

Determining the likelihood that the concatenated n-gram belongs to the first language may include basing the determination on an indication of relative frequency of occurrences of the concatenated n-gram in (a) the first language, versus (b) multiple languages. Basing the determination on an indication of relative frequency of occurrences may include basing the determination on the following term: (number of times the concatenated n-gram occurs in the first language)/(number of times the concatenated n-gram occurs in all languages under consideration).

Determining the likelihood that the concatenated n-gram belongs to the first language may include basing the determination on the following term: (0.5+(0.5*(number of times the n-gram occurs in the first language))/(number of times the most common n-gram occurs in the first language))*(number of times the concatenated n-gram occurs in the first language)/(number of times the concatenated n-gram occurs in all languages under consideration).

The method may include determining that the name is a surname, assigning a surname weight to the name based on the determination that the name is a surname, and determining a weighted likelihood that the surname belongs to the first language by multiplying the likelihood that the surname belongs to the first language by the surname weight. The method may include accessing a given name that corresponds to the surname, wherein the given name and the surname form a complete name. The method may include determining a likelihood that the given name belongs to the first language, assigning a given-name weight to the given name, and determining a weighted likelihood that the given name belongs to the first language by multiplying the likelihood that the given name belongs to the first language by the given-name weight. The method may include determining a likelihood that the complete name belongs to the first language by adding the weighted likelihood that the given name belongs to the first language and the weighted likelihood that the surname belongs to the first language.

The method may include determining that the name occupies a given name field of a larger name. The method may include determining that a second name occupies a second given name field of the larger name, wherein the name and the second name form a complete given name. The method may include accessing the second name, and determining a likelihood that the second name belongs to the first language. The method may include determining a likelihood that the complete given name belongs to the first language by averaging the two likelihoods.

Implementations may include hardware, a method or process, and/or code (software or firmware, for example) on a computer-accessible or processor-accessible medium. The hardware and/or the code may be configured or programmed to perform a method or process.

The details of one or more implementations are set forth in the accompanying drawings and the description below. Other features are apparent from the description and drawings, and from the claims.

### DETAILED DESCRIPTION

We now describe a particular implementation, and we include a description of a significant number of details to provide clarity in the description. All or most of the description below focuses on the particular implementation. That implementation may be expanded in various ways, all of which are not explicitly described below. However, one of ordinary skill in the art will readily understand and appreciate that various other implementations are both enabled and contemplated by this disclosure. By focusing on a particular implementation, the features are hopefully better described. However, such a focus does not limit the disclosure to just that implementation. Any language that might otherwise appear to be closed or limiting should generally be construed as being open and non-limiting, for example, by being construed to be referring to a specific implementation and not to be foreclosing other implementations.

The scoring logic used in one implementation is based in part on an analogy with algorithms commonly used to categorize documents in large collections to facilitate information retrieval. The research problem in document classification and retrieval is how to determine the relative weights the various words contained in a document should contribute to the overall “aboutness” of the document. Within document retrieval systems, this is often accomplished by measuring the Term Frequency—Inverse Document Frequency, or TF-IDF, for each term in a given document collection. The intuitive idea is that although a particular word may occur many times in a document, it is probably not very important if it also occurs in most or every document within the collection. For instance, a word like “the” will occur many times in a document, but will also occur in every document likely to be found in a collection. It should therefore not be a good indicator of any particular document, no matter how many times it may occur. The TF-IDF calculation quantifies this intuition.

Assume a document collection contains 2000 documents. Also assume word “A” occurs in the first document 10 times, as does the word “B.” The most commonly ocurring word in the document is “the,” which occurs 100 times. Word “A” appears in 15 documents across the collection, word “B” occurs in 400, and “the” occurs in all 2000 documents. Calculation of the TF-IDF scores for each of these words proceeds as follows:
TF=0.5+(0.5*nterm)/maxn,
where nterm=the number of times a word occurs in the document, and maxn=the number of times the most frequently occurring word occurs in the document. (There are other formulas out there for calculating term frequency, but this one seems to work well.)
IDF=log(ndocs/termdocs),
where ndocs=the number of documents in the collection and termdocs=the number of documents a particular term occurs in. (By using this ratio, we get the inverse; a term that occurs often will therefore have a small IDF calculation.)

TF-IDF is the product of these two numbers:
TF-IDF=TF*IDF
Since word “A” and word “B” each occur 10 times in the document we're examining, they will have the same TF score:
TF=0.5+(0.5*10)/100=0.55
Their IDF scores will differ, however, since they don't occur in the same number of documents.
IDF(A)=log(2000/15)=2.125
IDF(B)=log(2000/400)=0.699
The TF-IDF scores are:
TF-IDF(A)=0.55*2.125=1.16875
TF-IDF(B)=0.55*0.699=0.38445
Word “A” is therefore the better choice for classifying the example document, i.e., it is a better indicator of the document's “aboutness.”

What about the word “the,” which occurred most often in the document? It has a TF score of:
TF(the)=0.5+(0.5*100)/100=1.0,
which might indicate it's important. However, because it occurs in every document, its IDF is as low as it gets:
IDF(the)=log(2000/2000)=log(1)=0.
So the TF-IDF score for “the” will also be 0, indicating correctly that “the” is not a good indicator of the topic of the document.

This document retrieval approach can be modified and used on name classification. N-grams can be mapped onto words, and languages can be mapped onto documents. For the occurrence of any particular n-gram in a language, we need to find out how relevant that n-gram is for the identification of that language. Suppose, then, that in a particular example language (e.g., in a database of names for that language), n-gram “A” occurs 10 times, as does n-gram “B.” The most commonly occurring n-gram in the language occurs 100 times. The TF scores for these two n-grams are identical to the ones we calculated above for the words “A” and “” in our sample document, i.e., TF=0.55. At this point, however, the analogy with document retrieval breaks down. Although the number of n-grams is potentially huge (e.g., there are over 450,000 possible fourgram combinations), phonotactic constraints render most of these impossible for most languages. That is, many of the same n-grams are likely to be found in most languages. The number of n-grams that actually occur is much smaller and therefore identical n-grams are likely to occur in most languages. This fact would render the TF-IDF scores for most n-grams equivalent to the example we saw above with “the”: they would have relevance scores approaching 0. We would therefore have no way of determining whether n-gram “A” or n-gram “B” is a better indicator of our target language.

However, although it's likely that all of our languages will contain both our example n-grams, different languages will contain the n-grams with different frequencies, and we can use this information to predict how valuable any particular n-gram should be in identifying a language. Suppose n-gram “A” occurs 100 times across all the languages in our training set, while n-gram “B” occurs 500 times. Intuitively, n-gram “A” is more relevant in identifying our example language than is n-gram “B,” since 10% of the occurrences of n-gram “A” are in the example language (10 out of 100), while only 2% of the occurrences of n-gram “B” (10 out of 500) appear in the example language. N-gram “A” should therefore contribute more than n-gram “B” to the overall score of any name we're analyzing in our example language

To calculate a weighted n-gram score for a particular language, we multiply its TF value (i.e., the weighting based on how. often an n-gram occurs with respect to the most frequently occurring n-gram in the language) with its frequency of occurrence across all the languages we're interested in. (Analogous to our document retrieval example above, we might call this score the TF-LF score for Term Frequency-Language Frequency.) For the current example:
TF-LF(A):0.55*(10/100)=0.55*0.1=0.055
TF-LF(B):0.55*(10/500)=0.55*0.02 =0.011
This quantitatively captures the intuition that n-gram “A” is a better indicator of the example language than n-gram “B.” The LF portion is a distinct point of departure from the analogy with the document retrieval IDF system. The LF ratio (i) looks at the number of occurrences of n-grams, not the number of languages, (ii) counts occurrences in a given language, and (iii) does not invert the resulting ratio.

Experiments with both simple bigrams and simple fourgrams confirm the superiority of this TF-LF approach to scoring over the simple concatenation of probability scores, in which only the TF values are used. Scores with bigrams improved approximately 14% with this approach, while fourgram scores improved approximately 17%.

Based on the TF-LF formula just described, the ideal n-gram from a language identification perspective would have a score of 1.0, which is the maximum score. Such an n-gram would occur in only one language and it would be the most frequently occurring n-gram in the language. Assume, for example, that an n-gram occurs 50 times among all languages in the training sets and all those occurrences are in the same language. Assume further that the most frequent n-gram in that language occurs 50 times. The score for such an n-gram in that language would therefore be:
[0.5+(0.5*50)/50]*50/50=(0.5+0.5)*1.0=1.0
Positing the existence of such an ideal n-gram allows us to normalize scores even when names appear on lookup lists. Such hard-coded names are assumed to consist of ideal sixgrams and hence will always receive a score of 1.0. Since it is statistically highly unlikely for a name not on a lookup list to obtain such a score, hard-coded names always win while remaining on the same scale as names scored in the usual fashion. Scores are now always a number between 0 and 1.0, making it easier for customers to evaluate how likely it is a name might be from a culture other than the winning culture returned by the implementation.

The frequency counts used in calculating the TF-LF scores are static probability counts based on the occurrence of n-grams found in sets of training data. Two training sets are maintained for each language, one containing given name data and the other surname data. Separate training sets for the entire collection of given name and surname data from all of the languages combined (needed as described above to calculate the LF portion of the TF-LF score) are not maintained, but are created dynamically when The implementation is launched. This greatly simplifies upkeep of the training data since making changes to any individual set of training data does not require a second adjustment to a master list.

The parsing units (i.e., n-grams) for which probabilities are determined are sixgrams, based on concatenations of the trigrams found in a name. A sequential matrix of trigram combinations is created across the name in order to provide a more holistic assessment of the name's orthographic characteristics. First, the initial trigram in the name is combined with all successive trigrams in the name. The same process then proceeds from the second trigram in the word, and so on. For a name like <Smith>, the following sixgrams would be created. Note that the first and last trigrams assume a pad (space) on the ends of the name, and so only have two letters.

<SMSMI SMIMIT MITITH ITHTH>
<SMMIT SMIITH MITTH>
<SMITH SMITH>
<SMTH>

So, a score for the name Smith may be determined for each language by adding up the scores (TF-LF scores) of each n-gram above.

As mentioned above, one advantage of this approach is that various combinations of letter groupings in the name are used. This may simulate the process the human mind goes through while looking for recognizable patterns in a name. Another advantage of this approach is that it provides more material for measurement than simple n-grams alone. For instance, padded names broken into trigrams will always contain as many trigrams as there are letters in the word, e.g., <Smith> contains five: <SM SMI MIT ITH TH>. The same name using the whole-word approach yields ten units that can be measured. The following formula yields the number of sixgrams that will be created for a name (where n=the number of letters in the name):

$$\frac{n ( n - 1 )}{2}$$

For example, names of 4 letters yield 6 sixgrams, names of 5 letters yield 10 sixgrams, and names of 6 letters yield 15 sixgrams. Names with fewer than four letters will not benefit from this approach, i.e., names with three letters will contain three sixgrams; names with two letters will contain one; names consisting of a single letter cannot be analyzed with this algorithm since no sixgrams can be created from them. The average length of names in the Name Data Archive, however, is between six and seven letters; most names will therefore benefit from having the additional units to measure that the matrix concatenation approach provides.

The superiority of this approach was empirically confirmed through testing. Experimentation determined trigrams to be the optimal units to combine. Both bigram combinations (yielding fourgrams) and fourgram combinations (yielding eightgrams) scored lower in testing than the trigram combination pattern illustrated above. Using this whole-word matrix approach to create the parsing units resulted in an increase in accuracy rates of approximately 8% over using simple fourgrams alone, and an even greater improvement over simple trigrams.

As noted above, the implementation trains on given names and surnames separately, and a distinct score is generated for each field. These scores are combined in the following way to create the final, composite score.

Each field consists of zero or more strings. Each segment in each field is assigned a score for each of the cultures, and these scores are then averaged if there is more than one segment in a given field. For example, if John Jacob is entered into the given name field, each name (segment) is scored separately and the two are averaged to obtain the score for any given culture. At this point, each field has generated a vector of sixteen scores (or more, as the number of supported cultures increases). Finally a score for each culture is obtained by the following formula:
Total Score=(Surname score*0.6)+(Given name score*0.4)
The culture with the highest score is returned as our analysis of the name. The weights assigned to different fields may vary based on culture.

A number of implementations have been described. Nevertheless, it will be understood that various modifications may be made. For example, constants may be varied, scaling or normalizing or other factors may be used or varied, and the size of “n” in the n-grams may be varied even within the application of an implementation to a specific name. Accordingly, other implementations are within the scope of the following claims.

What is claimed is:

1. A method comprising: accessing a name;
dividing the name into a series of n-grams including at least a first n-gram and a second n-gram;
concatenating at least the first n-gram and the second n-gram to form a concatenated n-gram;
determining a likelihood that the concatenated n-gram belongs to a first language; and
determining a likelihood that the name belongs to the first language based on the likelihood that the concatenated n-gram belongs to the first language.

2. The method of claim 1 further comprising classifying the name as belonging to the first language based on the likelihood that the name belongs to the first language.

3. The method of claim 1 wherein the first n-gram and the second n-gram are not sequential.

4. The method of claim 1 wherein the first n-gram and the second n-gram overlap.

5. The method of claim 1 wherein the first n-gram and the second n-gram are separated in the name.

6. The method of claim 1 further comprising normalizing the likelihood that the name belongs to the first language.

7. The method of claim 1 further comprising determining likelihoods that each of a series of concatenated n-grams belong to the first language, and wherein determining the likelihood that the name belongs to the first language is based on the determined likelihoods that each of the series of concatenated n-grams belongs to the first language.

8. The method of claim 7 wherein determining the likelihood that the name belongs to the first language comprises adding up the likelihoods that each of the series of concatenated n-grams belong to the first language.

9. The method of claim 8 wherein determining the likelihood that the name belongs to the first language further comprises dividing the sum of the likelihoods by the number of concatenated n-grams added up.

10. The method of claim 1 further comprising determining a likelihood that the concatenated n-gram belongs to a second language.

11. The method of claim 10 further comprising determining a likelihood that the name belongs to the second language based on the likelihood that the concatenated n-gram belongs to the second language.

12. The method of claim 11 further comprising classifying the name as belonging to either the first language or second language based on the likelihoods that the name belongs to the first language and the second language.

13. The method of claim 1 wherein determining the likelihood that the concatenated n-gram belongs to the first language comprises basing the determination on the following term:
0.5+(0.5*(number of times the n-gram occurs in the first language))/(number of times the most common n-gram occurs in the first language)

14. The method of claim 1 wherein determining the likelihood that the concatenated n-gram belongs to the first language comprises basing the determination on an indication of relative frequency of occurrences of the concatenated n-gram in (a) the first language, versus (b) multiple languages.

15. The method of claim 14 wherein basing the determination on an indication of relative frequency of occurrences comprises basing the determination on the following term:
(number of times the concatenated n-gram occurs in the first language)/(number of times the concatenated n-gram occurs in all languages under consideration)

16. The method of claim 1 wherein determining the likelihood that the concatenated n-gram belongs to the first language comprises basing the determination on the following term:
(0.5+(0.5*(number of times the n-gram occurs in the first language))/(number of times the most common n-gram occurs in the first language))* (number of times the concatenated n-gram occurs in the first language)/(number of times the concatenated n-gram occurs in all languages under consideration)

17. The method of claim 1 further comprising:
determining that the name is a surname;
assigning a surname weight to the name based on the determination that the name is a surname;
determining a weighted likelihood that the surname belongs to the first language by multiplying the likelihood that the surname belongs to the first language by the surname weight;
accessing a given name that corresponds to the surname, wherein the given name and the surname form a complete name;
determining a likelihood that the given name belongs to the first language;
assigning a given-name weight to the given name;
determining a weighted likelihood that the given name belongs to the first language by multiplying the likelihood that the given name belongs to the first language by the given-name weight; and
determining a likelihood that the complete name belongs to the first language by adding the weighted likelihood that the given name belongs to the first language and the weighted likelihood that the surname belongs to the first language.

18. The method of claim 1 further comprising:
determining that the name occupies a given name field of a larger name;
determining that a second name occupies a second given name field of the larger name, wherein the name and the second name form a complete given name;
accessing the second name;
determining a likelihood that the second name belongs to the first language; and
determining a likelihood that the complete given name belongs to the first language by averaging the two likelihoods.
